(19) United States
(12) Patent Application Publication
(10) Pub. No.: US 2007/0276013 A1
(43) Pub. Date: Nov. 29, 2007

(54) Active Substance Combinations with Insecticidal Properties

(76) Inventors: Dirk Ebbinghaus, Wuppertal (DE); Andreas Hinterhuber, Bergisch Gladbach (DE); Wolfgang Thielert, Odenthal (DE); Heike Hungenberg, Langenfeld (DE); Holger Weckwert, Leichlingen (DE)

Correspondence Address: BAYER CROPSCIENCE LP, Patent Department, 2 T .W. ALEXANDER DRIVE, RESEARCH TRIANGLE PARK, NC, 27709, US

(21) Appl. No.: 10/588,616

(22) PCT Filed: Jan. 28, 2005
(86) PCT No.: PCT/EP05/00830

§ 371 Date: Apr. 13, 2007

(30) Foreign Application Priority Data
Feb. 10, 2004 (DE) 10 2004 006 324.9

(51) Int. Cl. A01N 55/10; A01N 43/40; A01P 17/00

(52) U.S. Cl. 514/342; 514/63

(57) ABSTRACT

The present invention relates to novel active substance combinations containing thiacloprid and at least one of the active substances (1) through (24) listed in the disclosure and having very good insecticidal characteristics.

The present invention concerns novel active substance combinations that consist of thiacloprid on one hand and other known insecticidal active substance on the other hand and are very well-suited for combating animal pests.

It is already known that thiacloprid of the formula 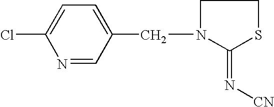
possesses insecticidal properties (EP 0 235 725).

Furthermore it is already known that pyrethroids possess insecticidal properties (compare WO 93-22 297, WO 93-10 083, DE-A 2 641 343, EP-A-347 488, EP-A-210 487, U.S. Pat. No. 3,264,177 and EP-A-234 045). However, the effect of these substances is not always satisfactory.

It was found that mixtures containing thiacloprid and at least one pyrethroid, preferably mixtures containing thiacloprid and

1. Acrinathrin 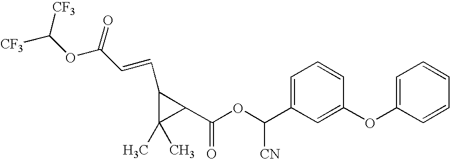
known from EP-A-048 186 and/or

2. Alpha-Cypermethrin 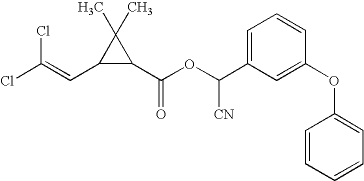
known from EP-A-067 461 and/or

3. Betacyfluthrin 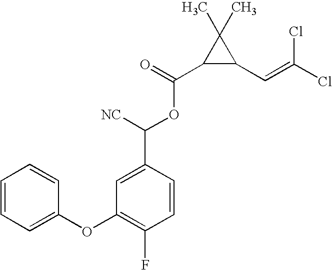
known from EP-A-206 149
and/or

4. Cyhalothrin 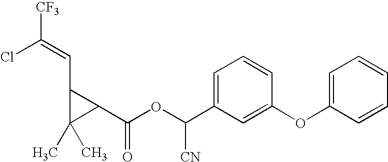
known from DE-A-2 802 962
and/or

5. Cypermethrin 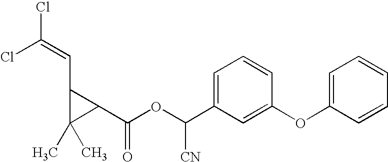
known from DE-A-2 326 077
and/or

6. Deltamethrin 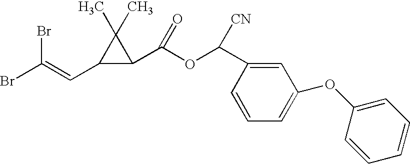
known from DE-A-2 326 077
and/or

7. Esfenvalerate 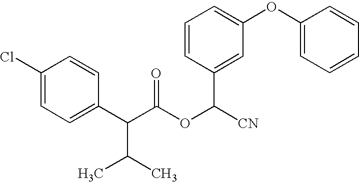
known from DE-A-2 737 297
and/or

8. Ethofenprox 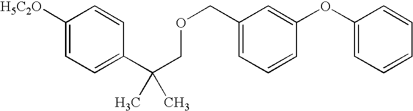
known from DE-A-3 117 510
and/or

9. Fenpropathrin 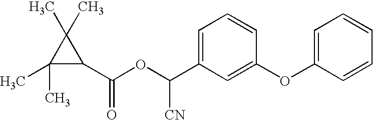
known from DE-A-2 231 312
and/or

10. Fenvalerate 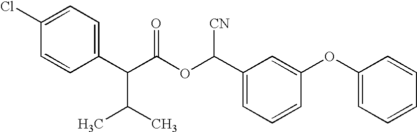
known from DE-A-2 335 347
and/or

11. Flucythrinate 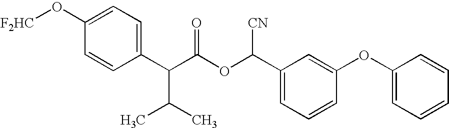
known from DE-A-2 757 066
and/or

12. Lambda-cyhalothrin 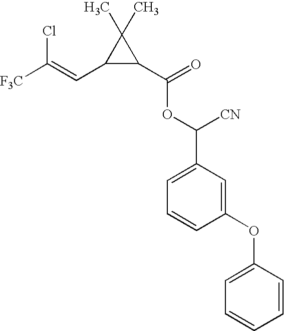
known from EP-A-106 469
and/or

13. Permethrin 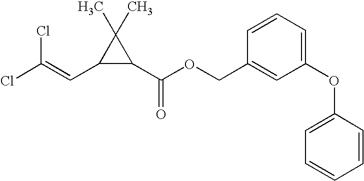
known from DE-A-2 326 077
and/or

14. Taufluvalinate 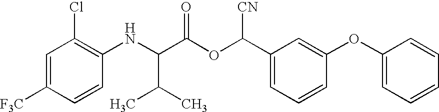
known from EP-A-038 617
and/or

15. Tralomethrin 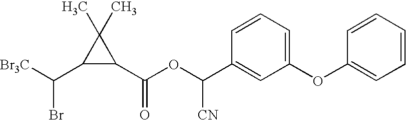
known from DE-A-2 742 546
and/or

16. Zeta-Cypermethrin 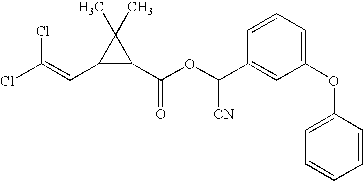
known from EP-A-026 542
and/or

17. Cyfluthrin 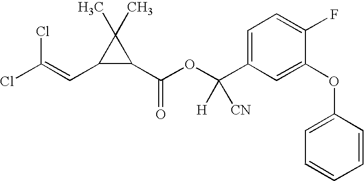
known from DE-A-27 09 264
and/or

18. Bifenthrin 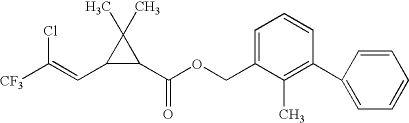
known from EP-A-049 977
and/or

19. Cycloprothrin 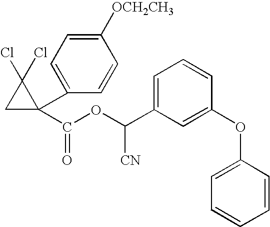
known from DE-A-2653189
and/or

20. Eflusilanate 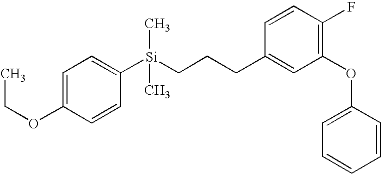
known from DE-A-36 04 781
and/or

21. Fubfenprox 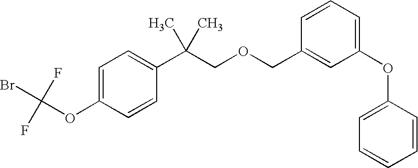
known from DE-A-37 08 231
and/or

22. Pyrethrin 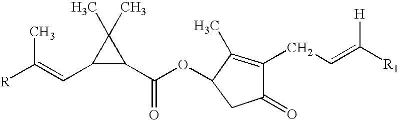
R=—CH₃ or —CO₂CH₃
R₁=—CH═CH₂ or —CH₃ or —CH₂CH₃
known from The Pesticide Manual 1997, issue 11, page 1056
and/or

23. Resmethrin 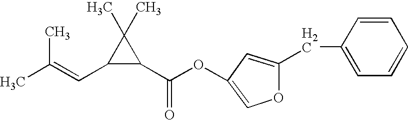
known from GB-A-1 168 797 and/or

24. Gamma-cyhalothrin 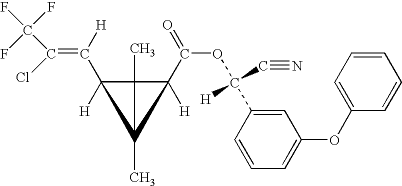
(known from “The Pesticide Manual, 13^{th} Edition, 2003, entry 197 on page 232, by The British Crop Protection Council)
possess very good insecticidal properties.

Surprisingly, the effect of the active substance combination according to the invention—especially its insecticidal effect—is substantially greater than the sum of the effects of the individual active substances. A true, unpredictable synergistic effect is present and not merely an action supplementation.

In addition to thiacloprid, the active substance combinations according to the invention contain at least one active substance from the compounds 1 through 24.

Furthermore, the active substance combinations can also contain additional fungicidally-, acaricidally- or insecticidally-active added components.

If the active substance in the active substance combinations is present in designated proportions by weight, the synergistic effect appears particularly clearly. However, the proportions by weight of the active substance in the active substance combinations can be varied in a relatively large range. In general, the combinations according to the invention contain thiacloprid and the mixture partner in the mixture proportions that are preferred and particularly preferred, as provided in the following table:

the mixture proportions are based on proportions by weight. The proportion is provided as thiacloprid:mixture partner

| | preferred mixture | particularly preferred |
|---|---|---|
| Mixture partner | proportion | mixture proportion |
| Acrinathrin | 125:1 to 1:25 | 1:1 to 1:25 |
| Alpha-cypermethrin | 125:1 to 1:25 | 1:1 to 1:25 |
| Betacyfluthrin | 125:1 to 1:25 | 1:1 to 1:25 |
| Cyhalothrin | 125:1 to 1:25 | 1:1 to 1:25 |
| Cypermethrin | 125:1 to 1:25 | 1:1 to 1:25 |
| Deltamethrin | 125:1 to 1:25 | 1:1 to 1:25 |
| Esfenvalerate | 125:1 to 1:25 | 1:1 to 1:25 |
| Etofenprox | 125:1 to 1:25 | 1:1 to 1:25 |
| Fenpropathrin | 125:1 to 1:25 | 1:1 to 1:25 |
| Fenvalerate | 125:1 to 1:25 | 1:1 to 1:25 |
| Flucythrinate | 125:1 to 1:25 | 1:1 to 1:25 |
| Lambda-cyhalothrin | 125:1 to 1:25 | 1:1 to 1:25 |
| Permethrin | 125:1 to 1:25 | 1:1 to 1:25 |
| Taufluvalinate | 125:1 to 1:25 | 1:1 to 1:25 |
| Tralomethrin | 125:1 to 1:25 | 1:1 to 1:25 |
| Zeta-cypermethrin | 125:1 to 1:25 | 1:1 to 1:25 |
| Cyfluthrin | 125:1 to 1:25 | 1:1 to 1:25 |
| Bifenthrin | 125:1 to 1:25 | 1:1 to 1:25 |
| Cycloprothrin | 125:1 to 1:25 | 1:1 to 1:25 |
| Eflusilanate | 125:1 to 1:25 | 1:1 to 1:25 |
| Fubfenprox | 125:1 to 1:25 | 1:1 to 1:25 |
| Pyrethrin | 125:1 to 1:25 | 1:1 to 1:25 |
| Resmethrin | 125:1 to 1:25 | 1:1 to 1:25 |
| Gamma-cyhalothrin | 125:1 to 1:25 | 1:1 to 1:25 |

With good plant compatibility, favorable toxicity to endotherms and good environmental compatibility, the active substance combinations according to the invention are suitable for the protection of plants and plant organs, for increases in crop yields, improvement of the quality of harvested goods and for combating animal pests, in particular insects, arachnids and nematodes that are found in agriculture, in forests, in the garden and recreational facilities, in the protection of inventory and materials as well as in the hygiene sector. Preferably, they can be deployed as a means of plant protection. They are effective against normally-sensitive and resistant species as well as against all or particular development stages. To the pests mentioned above belong:

From the order of the Isopoda, for example, Oniscus asellus, Armadillidium vulgare, Porcellio scaber.

From the order of the Diplopoda, for example, Blaniulus guttulatus.

From the order of the Chilopoda, for example, Geophilus carpophagus, Scutigera spp.

From the order of the Symphyla, for example, Scutigerella immaculata.

From the order of the Thysanura, for example, Lepisma saccharina.

From the order of the Collembola, for example, Onychiurus armatus.

From the order of the Orthoptera, for example, Acheta domesticus, Gryllotalpa spp., Locusta migratoria migratorioides, Melanoplus spp., Schistocerca gregaria.

From the order of the Blattaria, for example, Blatta orientalis, Periplaneta americana, Leucophaea maderae, Blattella germanica.

From the order of the Dermaptera, for example, Forficula auricularia.

From the order of the Isoptera, for example, Reticulitermes spp.

From the order of the Phthiraptera, for example, Pediculus humanus corporis, Haematopinus spp., Linognathus spp., Trichodectes spp., Damalinia spp.

From the order of the Thysanoptera, for example, Hercinothrips femoralis, Thrips tabaci, Thrips palmi, Frankliniella accidentalis.

From the order of the Heteroptera, for example, Eurygaster spp., Dysdercus intermedius, Piesma quadrata, Cimex lectularius, Rhodnius prolixus, Triatoma spp.

From the order of the Homoptera, for example, Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp., Psylla spp.

From the order of the Lepidoptera, for example, Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp., Oulema oryzae.

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica, Lissorhoptrus oryzophilus.

From the order of the Hymenoptera, for example, Diprion spp., Hoplocampa spp., Lasius spp., Monomorium pharaonis, Vespa spp.

From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp., Liriomyza spp.

From the order of the Siphonaptera, for example, Xenopsylla cheopis, Ceratophyllus spp.

From the class of the Arachnida, for example, Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp.

To the plant parasites Nematodes belong, for example, Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp.

According to the invention all plans and plant parts can be treated. In this respect, under plants are understood all plants and plant populations, such as desired and undesired wild plants or crops (including naturally-occurring crops). Grains (wheat, oats, barley, rye, rice), corn, soy, potato, cotton, tobacco, rape as well as fruit plants (with the fruits apple, pears, citrus fruits and wine grapes) are mentioned as crops. Crops can be plants that can be obtained by means of conventional breeding and optimization methods or by means of biotechnological and genetic methods or combinations of these methods, including the transgenic plants and including the plant species protectable or not protectable by species trademark. Under plant parts are included all above-ground and underground parts and organs of the plants, such as shoot, foliage, bloom and root, whereby leaves, needles, stalks, stems, blossoms, fruit bodies, fruits and seeds as well as roots, bulbs and rhizomes are listed by way of example. Also belonging to plant parts are harvested goods as well as vegetative and generative increase material, for example, cuttings, bulbs, rhizomes, scions and seeds.

The treatment of plants and plant parts with the active substance combinations according to the invention takes place directly or by means of action on their environment, habitat or storage area in accordance with the conventional treatment methods, for example, by means of immersion, spraying, vaporizing, atomizing, scattering, spreading, injecting, and for increase material, in particular for seeds, furthermore by means of single- or multi-layered coatings.

The active substance combinations can be carried in the conventional formulations like solutions, emulsions, injection powders, suspensions, powders, dust media, pastes, dissolved powders, granulates, suspension-emulsion concentrates, active-substance-impregnated natural and synthetic substances and micro-encapsulations in polymeric substances.

These formulations are produced in the known ways, for example, by mixing the active substances with extenders and liquid solvents and/or solid carrier substances, if necessary by using surface-active media and emulsifiers and/or dispersants and/or foaming media.

In the case that water is used as an extender, organic solvents can also be used as auxiliary solvents. Qualified as liquid solvents are: aromatics like xylol, toluol or aklynaphthalines, chlorinated aromatics and chlorinated aliphatic hydrocarbons like chlorobenzenes, chlorethylene or methylene chloride, aliphatic hydrocarbons like cyclohexane or paraffins, for example, mineral oil fractions, mineral and vegetable oils, alcohols like butanol or glycol as well as their ethers and esters, ketones like acetone, methyl ethyl ketone, methyl isobutyl ketone or cyclohexanone, strongly polar solvents like dimethylformamide and dimethyl sulphoxide, as well as water.

Qualified as solid carrier substances are:

for example, ammonium salts and natural rock flours like kaoliniite, clay, talcum, chalk, quartz, attapulgite, montmorillonite or diatomaceous earth and synthetic rock flours like highly-dispersed silicon dioxide, aluminum oxide and silicates; qualified as solid carrier substances for granulates are: for example, broken and fractioned natural rocks like calcite, marble, pumice, sepiolite, dolomite as well as synthetic granulates from inorganic and organic flours as well as granulates from organic material like sawdust, coconut shells, corn cobs, and tobacco stalks; qualified as emulsifying and/or foaming medium are: for example, non-ionizable and anionic emulsifiers like polyoxyethylene fatty acid esters, polyoxyethylene fatty alcohol ethers, for example, alkylaryl polyglycol ether, alkyl sulphonates, alkyl sulphates, aryl sulphonates as well as initial hydrolysates; qualified as dispersants are: for example, lignin-sulphite waste liquor and methyl cellulose.

Adhesives like carboxymethylcellulose, natural and synthetic powdered, granulated or latex polymers can be used in the formulations, such as arabica gum, polyvinyl alcohol, polyvinyl acetate, as well as natural phospholipids like cephaline and lecithin and synthetic phospholipids. Mineral and vegetable oils can be additional additives.

Dyestuffs such as inorganic pigments, for example, iron oxide, titanium oxide, ferrocyan blue and organic dyestuffs like alizarin-, azo- and metal phthalo blue dyestuffs and trace nutrients like salts of iron, manganese, boron, copper, cobalt, molybdenum and zinc can be used.

The formulations generally contain between 0.1 and 95% by weight of active substance, preferably between 0.5 and 95%.

In their traditional commercial formulations and in the application forms prepared from these formulations, the active substance combinations according to the invention can be available in mixture with other active substances like insecticides, attractants, sterilants, bactericides, acaricides, nematicides, fungicides, substances that regulate growth or herbicides. Counted among the insecticides are, for example, phosphoric acid esters, carbamates, carboxylic acid esters, chlorinated hydrocarbons, phenyl ureas, substances produced by microorganisms, and others.

Especially favorable mixture partners are, for example, the following:

Fungicides:

2-phenylphenol; 8-hydroxyquinoline sulphate; acibenzolar-5-methyl; aldimorph; amidoflumet; ampropylfos; ampropylfos-potassium; andoprim; anilazine; azaconazole; azoxystrobin; benalaxyl; benodanil; benomyl; benthiavalicarb-isopropyl; benzamacril; benzamacril-isobutyl; bilanafos; binapacryl; biphenyl; bitertanol; blasticidin-S; bromuconazole; bupirimate; buthiobate; butylamine; calcium polysulphide; capsimycin; captafol; captan; carbendazim; carboxin; carpropamide; carvone; chinomethionate; chlobenthiazone; chlorfenazole; chloroneb; chlorothalonil; chlozolinate; clozylacon; cyazofamid; cyflufenamid; cymoxanil; cyproconazole; cyprodinil; cyprofuram; Dagger G; debacarb; dichlofluanid; dichlone; dichlorophen; diclocymet; diclomezine; dicloran; diethofencarb; difenoconazole; diflumetorim; dimethirimol; dimethomorph; dimoxystrobin; diniconazole; diniconazole-M; dinocap; diphenylamine; Dipyrithione; ditalimfos; dithianon; dodine; drazoxolon; edifenphos; epoxiconazole; ethaboxam; ethirimol; etridiazole; famoxadone; fenamidone; fenapanil; fenarimol; fenbuconazole; fenfuram; fenhexamid; fenitropan; fenoxanil; fenpiclonil; fenpropidin; fenpropimorph; ferbam; fluazinam; flubenzimine; fludioxonil; flumetover; flumorph; fluoromide; fluoxastrobin; fluquinconazole; flurprimidol; flusilazole; flusulphamide; flutolanil; flutriafol; folpet; fosetyl-AI; fosetyl-sodium; fuberidazole; furalaxyl; furametpyr; furcarbanil; furmecyclox; guazatine; hexachlorobenzene; hexaconazole; hymexazol; imazalil; imibenconazole; iminoctadine triacetate; iminoctadine tris(albesilate); iodocarb; ipconazole; iprobenfos; iprodione; iprovalicarb; irumamycin; isoprothiolane; isovaledione; kasugamycin; kresoxim-methyl; mancozeb; maneb; meferimzone; mepanipyrim; mepronil; metalaxyl; metalaxyl-M; metconazole; methasulphocarb; methfuroxam; metiram; metominostrobin; metsulphovax; mildiomycin; myclobutanil; myclozolin; natamycin; nicobifen; nitrothal-isopropyl; noviflumuron; nuarimol; ofurace; orysastrobin; oxadixyl; oxolinic acid; oxpoconazole; oxycarboxin; oxyfenthiin; paclobutrazol; pefurazoate; penconazole; pencycuron; phosdiphen; phthalide; picoxystrobin; piperalin; polyoxins; polyoxorim; probenazole; prochloraz; procymidone; propamocarb; propanosine-sodium; propiconazole; propineb; proquinazid; prothioconazole; pyraclostrobin; pyrazophos; pyrifenox; pyrimethanil; pyroquilon; pyroxyfur; pyrrolnitrine; quinconazole; quinoxyfen; quintozene; simeconazole; spiroxamine; sulphur; tebuconazole; tecloftalam; tecnazene; tetcyclacis; tetraconazole; thiabendazole; thicyofen; thifluzamide; thiophanate-methyl; thiram; tioxymid; tolclofos-methyl; tolylfluanid; triadimefon; triadimenol; triazbutil; triazoxide; tricyclamide; tricyclazole; tridemorph; trifloxystrobin; triflumizole; triforine; triticonazole; uniconazole; validamycin A; vinclozolin; zineb; ziram; zoxamide; (2S)—N-[2-[4-[[3-(4-chlorophenyl)-2-propynyl]oxy]-3-methoxyphenyl]ethyl]-3-methyl-2-[(methylsulphonyl)amino]-butanamide; 1-(1-naphthalenyl)-1H-pyrrole-2,5-dione; 2,3,5,6-tetrachloro-4-(methylsulphonyl)-pyridine; 2-amino-4-methyl-N-phenyl-5-thiazolecarboxamide; 2-chloro-N-(2,3-dihydro-1,1,3-trimethyl-1H-inden-4-yl)-3-pyridincarboxamide; 3,4,5-trichloro-2,6-pyridinedicarbonitrile; Actinovate; cis-1-(4-chlorophenyl)-2-(1H-1,2,4-triazole-1-yl)-cycloheptanol; methyl 1-(2,3-dihydro-2,2-dimethyl-1H-inden-1-yl)-1H-imidazole-5-carboxylate; monopotassium carbonate; N-(6-methoxy-3-pyridinyl)-cyclopropanecarboxamide; N-butyl-8-(1,1-dimethylethyl)-1-oxaspiro[4.5]decan-3-amine; sodium tetrathiocarbonate;

as well as copper salts and preparations like Bordeaux mixture; copper hydroxide; copper naphthenate; copper oxychloride; copper sulphate; cufraneb; cuprous oxide; mancopper; oxine-copper.

Bactericides:

bronopol, dichlorophen, nitrapyrin, nickel-dimethyldithiocarbamate, kasugamycin, octhilinon, furan carboxylic acid, oxytetracyclin, probenazole, streptomycin, tecloftalam, copper sulphate and other copper preparations.

Insecticides/acaricides/nematicides

1. Acetylcholinesterase (AChE) inhibitors
1.1 Carbamates, for example,
   alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulphan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb
   Triazamates
1.2 Organophosphates, for example,
   acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsulphone, dialifos, diazinon, dichlofenthion, dichlorvos/DDVP, dicrotophos, dimethoate, dimethylvinphos, dioxabenzofos, disulphoton, EPN, ethion, ethoprophos, Etrimfos, famphur, fenamiphos, fenitrothion, fensulphothion, fenthion, flupyrazofos, fonofos, formothion, fosmethilan, fosthiazate, heptenophos, iodofenphos, iprobenfos, isazofos, isofenphos, isopropyl o-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulphotep, sulprofos, tebupirimfos, temephos, terbufos, tetrachlorvinphos, thiometon, triazophos, triclorfon, vamidothion
2. Sodium channel modulators/voltage-dependent sodium channel blockers
2.1 Pyrethroids, for example,
   Acrinathrin, allethrin (d-cis-trans, d-trans), beta-cyfluthrin, bifenthrin, bioallethrin, bioallethrin-5-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, taufluvalinate, tefluthrin, terallethrin, tetramethrin (-1R-isomer), tralomethrin, transfluthrin, ZXI 8901, pyrethrins (pyrethrum)
   DDT
2.2 Oxadiazines, for example, indoxacarb
3. Acetylcholine receptor agonists/antagonists
3.1 Chloronicotinyls, for example,
   Acetamiprid, clothianidin, dinotefuran, imidacloprid, nitenpyram, nithiazine, thiacloprid, thiamethoxam
3.2 Nicotine, bensultap, cartap
4. Acetylcholine receptor modulators
4.1 Spinosyns, for example, spinosad
5. GABA-gated chloride channel antagonists
5.1 Cyclodiene organochlorines, for example,
   Camphechlor, chlordane, endosulphan, gamma-HCH, HCH, heptachlor, lindane, methoxychlor
5.2 Fiproles, for example,
   Acetoprole, ethiprole, fipronil, vaniliprole
6. Chloride channel activators
6.1 Mectins, for example,
   Avermectin, emamectin, emamectin-benzoate, ivermectin, milbemycin
7. Juvenile hormone mimics, for example,
   Diofenolan, epofenonane, fenoxycarb, hydroprene, kinoprene, methoprene, pyriproxifen, triprene
8. Ecdyson agonists/disruptors
8.1 Diacylhydrazines, for example,
   Chromafenozide, halofenozide, methoxyfenozide, tebufenozide
9. Inhibitors of chitin biosynthesis
9.1 Benzoyl ureas, for example,
   Bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron
9.2 Buprofezin
9.3 Cyromazine
10. Inhibitors of oxidative phosphorylation, ATP disruptors
10.1 Diafenthiuron
10.2 Organotins, for example, azocyclotin, cyhexatin, fenbutatin oxide
11. Decouplers of the oxidative phosphorylation through interruption of the H-proton gradients
11.1 Pyrroles, for example, chlorfenapyr
11.2 Dinitrophenols, for example, binapacryl, dinobuton, dinocap, DNOC
12. Site I electron transport inhibitors
12.1 METIs, for example, fenazaquin, fenpyroximate, pyrimidifen, pyridaben, tebufenpyrad, tolfenpyrad
12.2 Hydramethylnon
12.3 Dicofol
13. Site II electron transport inhibitors
   Rotenone
14. Site III electron transport inhibitors
   Acequinocyl, fluacrypyrim
15. Microbial disruptors of the insect gut membrane
   Bacillus thuringiensis strains
16. Inhibitors of fat synthesis
   Tetronic acids, for example,
      Spirodiclofen, spiromesifen
   Tetramic acids, for example,
      3-(2,5-dimethylphenyl)-8-methoxy-2-oxo-1-azaspiro[4,5]dec-3-en-4-yl ethyl carbonate (alias: carbonic acid, 3-(2,5-dimethylphenyl)-8-methoxy-2-oxo-1-azaspiro[4,5]dec-3-en-4-yl ethyl ester, CAS-Reg.-No.: 382608-10-8) and carbonic acid, cis-3-(2,5-dimethylphenyl)-8-methoxy-2-oxo-1-azaspiro[4,5]dec-3-en-4-yl ethyl ester (CAS-Reg.-No.: 203313-25-1)
17, Carboxamides, for example, flonicamid
18. Octopaminergic agonists, for example, amitraz
19. Inhibitors of the magnesium-stimulated ATPase, for example, propargite
20. BDCAs, for example, N2-[1,1-dimethyl-2-(methylsulphonyl)ethyl]-3-iodo-N1-[2-methyl-4-[1,2,2,2-tetrafluoro-1-(trifluoromethyl)ethyl]phenyl]-1,2-benzenedicarboxamide (CAS-Reg.-No.: 272451-65-7)
21. Nereistoxin analogs, for example thiocyclam hydrogen oxalate, thiosultap sodium
22. Biologics, hormones or pheromones, for example,
   Azadirachtin, Bacillus spec., Beauveria spec., codlemone, Metarrhizium spec., Paecilomyces spec., thuringiensin, Verticillium spec.
23. Active substances with unknown or nonspecific action mechanisms
23.1 Gassing agents, for example,
   Aluminum phosphide, methyl bromide, sulphuryl fluoride
23.2 Selective grub suppressors, for example,
   Cryolite, flonicamid, pymetrozine
23.3 Mite growth inhibitors, for example,
   Clofentezine, etoxazole, hexythiazox
23.4 Amidoflumet, benclothiaz, benzoximate, bifenazate, bromopropylate, buprofezin, chinomethionate, chlordimeform, chlorobenzilate, chloropicrin, clothiazoben, cycloprene, di-cyclanil, fenoxacrim, fentrifanil, flubenzimine, flufenerim, flutenzin, gossyplure, hydra-methylnone, japonilure, metoxadiazone, petroleum, piperonyl butoxide, potassium oleate, pyridalyl, sulphluramid, tetradifon, tetrasul, triarathene, verbutin, Verticillium lecanii,
WL-108477, WL-40027,
YI-5201, YI-5301, YI-5302,
XMC, xylylcarb,
ZA-3274, zeta-cypermethrin, zolaprofos, ZXI-8901,
   the compound 3-methyl-phenyl-propyl carbamate (tsumacide Z),
   the compound 3-(5-chloro-3-pyridinyl)-8-(2,2,2-trifluorethyl)-8-azabicyclo[3.2.1]octan-3-carbonitrile (CAS-Reg.-No. 185982-80-3) and the corresponding 3-endo-isomers (CAS-Reg.-Nr. 185984-60-5) (compare WO-96/37494, WO-98/25923),
   as well as preparations which contain insecticidally-effective plant extracts, nematodes, fungi or viruses.

In addition, a mixture with other known active substance such as herbicides, fertilisers, growth regulators, safeners or semiochemicals is possible.

When used as insecticides in their traditional commercial formulations and in the application forms prepared from these formulations, the active substance combinations according to the invention can also be available in mixture with synergists. Synergists are compounds that improve the action of the active substance without the added synergist itself being required to be active.

When used as insecticides in their traditional commercial formulations and in the application forms prepared from these formulations, the active substance combinations according to the invention can also be available in mixture with inhibitors that reduce a degradation of the active substances after application into the environment of the plant, on the surface of plant parts or in the plant tissues.

The concentration of active substance in traditional commercial formulations and prepared application forms can vary within a wide range. The concentration of active substance in the application forms can be from 0.0000001 up to 95% by weight active substance, preferably between 0.0001 and 1% by weight.

The application occurs in one of the application forms customised in the traditional way.

When used against hygienic and storage pests, the active substance features an outstanding residual effect on wood and clay as well as a good alkaline stability on calcareous substrates.

As already mentioned above, according to the invention all plants and their parts can be treated. In a preferred implementation form, plant types and plant species and their parts, from the wild or obtained by conventional biological breeding methods like crossing or protoplasmic infusion, are treated. In another preferred implementation form, transgenic plant types and plant species that are obtained by genetic technology methods and, if applicable, in combination with conventional methods (Genetic Modified Organisms) and their parts are treated. The term “parts” or “parts of plants” or “plant parts” was explained above.

Particularly preferred are plants of the respective plant species traditional in commerce or in use which are treated according to the invention. Under plant species, one understands plants with novel characteristics (“Traits”) that had been cultivated either through conventional breeding, by mutagenesis or by recombinant DNA techniques. The can be species, bio- and genotypes.

Depending on plant types or plant species and their location and growth conditions (soils, climate, vegetation periods, nutrition), exponential (“synergistic”) effects can also appear by means of the treatment according to the invention. Thus are possible, for example, reduced application rates and/or extensions of the action spectrum and/or a strengthening of the action of the usable substances and means according to the invention, better plant growth, increased tolerance to higher or lower temperatures, increased tolerance against drought or against water or soil salt content, increased blossom yield, simpler harvest, acceleration of maturity, higher crop yields, higher quality and/or higher nutritional value of the harvested goods, longer shelf life and/or machinability of the harvested goods, which exceed the actual expected effects.

All plants obtained by genetic modification of genetic material that imparts to these plants particularly advantageous valuable characteristics (“Traits”) belong to the preferred transgenic (obtained by genetic technology) plants or plant species to be treated according to the invention. Examples of such characteristics are better plant growth, increased tolerance to higher or lower temperatures, increased tolerance against drought or against water or soil salt content, increased blossom yield, simpler harvest, acceleration of maturity, higher crop yields, higher quality and/or higher nutritional value of the harvested goods, longer shelf life and/or machinability of the harvested goods. Additional and particularly emphasised examples of such characteristics are an increased defense by plants against animal and microbial pests, such as against insects, mites, plant pathogenic fungi, bacteria and/or viruses as well as an increased tolerance of the plants against designated herbicidal active substances. The important crops such as grains (wheat, rice), corn, soy, potato, cotton, tobacco, rape as well as fruit plants (with the fruits apple, pears, citrus fruits and wine grapes) are mentioned as examples of transgenic plants, whereas corn, soy, potatoes, cotton, tobacco and rape are particularly emphasised. Particularly emphasised as characteristics (“Traits”) are the increased defenses by plants against insects, arachnids, nematodes and snails by toxins originating from the plants, in particular those that are created by means of the genetic material from Bacillus thuringiensis (“Bt crops”) (for example through the genes CryIA(a), CryIA(b), CryIA(c), CryIIA, CryIIIA, CryIIIB2, Cry9c Cry2Ab, Cry3Bb and CrylF as well as their combinations). Also particularly emphasised as characteristics (“Traits”) are the increased defenses by plants against fungi, bacteria and viruses through systemically-acquired resistance (SAR), systemins, phytoalexines, elicitors as well as resistance genes and correspondingly-expressed proteins and toxins. Furthermore, particularly emphasised as characteristics (“Traits”) are the increased tolerance of the plants against designated herbicidal active substances, for example, imidazolinones, sulphonyl ureas, glyphosate or phosphinotricin (for example “PAT” gene). The respective genes imparting the desired characteristics (“Traits”) can also appear in combination with each other in the transgenic plants. Corn species, cotton species, soy species and potato species are mentioned as examples of “Bt crops” which are marketed under the commercial name YIELD GARD® (for example, corn, cotton, soy), KnockOut® (for example, corn), StarLink® (for example, corn), Bollgard® (cotton), Nucotn® (cotton) and NewLeaf® (potato). Corn species, cotton species and soy species are mentioned as examples of herbicide-tolerant plants which are marketed under the commercial name Roundup Ready® (tolerance against glyphosate, for example, corn, cotton, soy), Liberty Link® (tolerance against phosphinotricin, for example, rape), IMI® (tolerance against imidazolinone) and STS® (tolerance against sulphonyl urea, for example, corn). Also mentioned as herbicide-resistant (conventionally cultivated for herbicide tolerance) plants are the species (for example, corn) marketed under the name Clearfield®. Of course, these statements also apply for the plant species developed in the future or coming onto the market in the future with these or to-be-developed genetic characteristics (“Traits”).

The listed plants can be treated particularly advantageously according to the invention with the active substance mixtures according to the invention. The priority domains for the mixtures listed above also apply for the treatment of these plants. Particularly emphasised is the plant treatment with the compounds or mixtures specifically listed in the present text.

The active substance combinations according to the invention act not only against plant-, hygienic- and storage pests, but also in the veterinary medicine sector against animal parasites (ectoparasites) like hard ticks, soft ticks, scabies mites, running mites, flies (stinging and licking), parasitic fly larvae, lice, hair lice, feather lice and fleas. To these parasites belong:

From the order of the Anoplura, for example, Haematopinus spp., Linognathus spp., Pediculus spp., Phtirus spp., Solenopotes spp.

From the order of the Mallophaga and the suborders Amblycera and Ischnocera, for example, Trimenopon spp., Menopon spp., Trinoton spp., Bovicola spp., Werneckiella spp., Lepikentron spp., Damalina spp., Trichodectes spp., Felicola spp.

From the order Diptera and the suborder Nematocera and Brachycera, for example, Aedes spp., Anopheles spp., Culex spp., Simulium spp., Eusimulium spp., Phlebotomus spp., Lutzomyia spp., Culicoides spp., Chrysops spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp., Melophagus spp.

From the order of the Siphonapterida, for example, Pulex spp., Ctenocephalides spp., Xenopsylla spp., Ceratophyllus spp.

From the order of the Heteroptera, for example, Cimex spp., Triatoma spp., Rhodnius spp., Panstrongylus spp.

From the order of the Blattaria, for example, Blatta orientalis, Periplaneta americana, Blattela germanica, Supella spp.

From the subclass of the Acari (Acari) and the order of the Meta- and Mesostigmata, for example, Argas spp., Ornithodorus spp., Otobius spp., Ixodes spp., Amblyomma spp., Boophilus spp., Dermacentor spp., Haemophysalis spp., Hyalomma spp., Rhipicephalus spp., Dermanyssus spp., Raillietia spp., Pneumonyssus spp., Stemostoma spp., Varroa spp.

From the order of the Actinedida (Prostigmata) und Acaridia (Astigmata), for example, Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., Laminosioptes spp.

The active substance combinations according to the invention of the formula (I) are also suitable for combating arthropods that affect agricultural livestock, such as, for example, cattle, sheep, goats, horses, pigs, donkeys, camels, buffalo, rabbits, chickens, turkeys, ducks, geese, bees, other domestic animals such as, for example, dogs, cats, domesticated birds, aquarium fish as well as so-called laboratory animals, such as, for example, hamsters, guinea pigs, rats and mice. By combating these arthropods, deaths and performance reduction (for meat, milk, wool, skins, eggs, honey, etc.) are decreased such that more economical and simpler livestock husbandry is possible through the use of the active substances according to the invention.

The use of the active substance combinations according to the invention occurs in the veterinary sector in known ways by means of enteral administration in the form of, for example, tablets, capsules, drinks, drenches, granulates, pastes, boli, of the feed-through procedure, of suppositories, through parenteral administration such as, for example, through injections (intramuscular, subcutaneous, intravenous, intraperitonal, and others), implants, through nasal application, through dermal administration in the form of, for example, immersion or baths (dips), sprays, infusions (pour-on and spot-on), washes, dustings as well as with the assistance of molded objects containing active substance such as collars, ear markers, tail markers, limb bands, halters, marking devices and so forth.

When used for cattle, poultry, domestic animals, etc.; one can apply the active substance combinations as formulations (for example powders, emulsions, flowing medium) that contain the active substances in an amount from 1 to 80% by weight, directly or after dilution of 100 to 10,000 times, or as a chemical bath.

In addition, it is found that the active substance combinations according to the invention exhibit an elevated insecticidal action against insects that technical materials eliminate.

By way of example and preference—without limitation, however—the following insects are mentioned:

Beetles such as Hylotrupes bajulus, Chlorophorus pilosis, Anobium punctatum, Xestobium rufovillosum, Ptilinus pecticornis, Dendrobium pertinex, Ernobius mollis, Priobium carpini, Lyctus brunneus, Lyctus africanus, Lyctus planicollis, Lyctus linearis, Lyctus pubescens, Trogoxylon aequale, Minthes rugicollis, Xyleborus spec. Tryptodendron spec. Apate monachus, Bostrychus capucins, Heterobostrychus brunneus, Sinoxylon spec. Dinoderus minutus;

Hymenoptera such as Sirex juvencus, Urocerus gigas, Urocerus gigas taignus, Urocerus augur;

Termites such as Kalotermes flavicollis, Cryptotermes brevis, Heterotermes indicola, Reticulitermes flavipes, Reticulitermes santonensis, Reticulitermes lucifugus, Mastotermes darwiniensis, Zootermopsis nevadensis, Coptotermes formosanus;

Silverfish such as Lepisma saccharina.

In the present context, technical materials is to be understood as non-living materials, such as, preferably, plastics, adhesives, glues, papers and cartons, leather, wood, wood-working products, and coating materials.

Quite particularly preferred are materials to be protected from insect attack involving wood and wood-working products.

Under wood and wood-working products which can be protected by the agents according to the invention or mixtures that contain it, is to be understood to mean:

lumber, wood beams, railway sleepers, bridge parts, boat moorings, wooden vehicles, boxes, pallets, containers, telephone poles, wood panelling, wooden windows and doors, plywood, chipboard, carpentry or wood products generally found in house construction or in carpentry use.

The active substances can also be used in the form of concentrates or general, traditional formulations such as powders, granulates, solutions, suspensions, emulsions or pastes.

The mentioned formulations can be produced in a known way, for example, by mixing the active substances with at least one solvent or dilutant, emulsifier, dispersing and/or binding or fixing medium, water repellent, if applicable siccatives and UV stabilisers and if applicable dyestuffs and pigments as well as additional processing additives.

The insecticidal medium or concentrate used for the protection of wood and wood-working materials contains the active substance according to the invention in a concentration of from 0.0001 to 95% by weight, in particular 0.001 to 60% by weight.

The amount of the medium or concentrate introduced is dependent on the type and the features of the insects and on the medium. The optimal application amount in each case can be determined through the use of test sequences. In general, however, it is sufficient to introduce 0.0001 to 20% by weight, preferably 0.001 to 10% by weight of active substance, in terms of the material to be protected.

An organic chemical solvent or solvent mixture and/or an oily or oil-like highly volatile organic chemical solvent or solvent mixture and/or a polar organic chemical solvent or solvent mixture and/or water and, if applicable, an emulsifier and/or wetting agent serves as solvent and/or dilutant.

An oily or oil-like solvent with an evaporation number over 35 and a flame point over 30° C., preferably over 45° C., is preferably used as an organic chemical solvent. Mineral oils or their aromatic fractions or solvent mixtures containing mineral oils, preferably white spirit, petroleum and/or alkyl benzene are correspondingly used as such a high-volatility, water-insoluble, oily and oil-like solvent.

Mineral oils with a boiling range of from 170 to 220° C., white spirit with a boiling range of from 170 to 220° C., low-viscosity lubricating oil with a boiling range of from 250 to 350° C., petroleum or aromatics with a boiling range of from 160 to 280° C., turpentine oil and such are advantageous for use.

In a preferred application form, liquid aliphatic hydrocarbons with a boiling range of from 180 to 210° C. or high-boiling mixtures of aromatic and aliphatic hydrocarbons with a boiling range of from 180 to 220° C. and/or low-viscosity lubricating oil and/or monochloro naphthaline, preferably α-monochloro naphthaline, are used.

The organic high-volatility oily or oil-like solvents with a evaporation number over 35 and a flame point over 30° C., preferably over 45° C., can be partially replaced by low or medium-volatility organic chemical solutions with the requirement that the solvent mixture likewise exhibits an evaporation number over 35 and a flame point over 30° C., preferably over 45° C., and that the insecticide-fungicide mixture is soluble or emulsifiable in this solvent mixture.

According to a preferred application form, a part of the organic chemical solvent or solvent mixture or an aliphatic polar organic chemical solvent or solvent mixture is replaced. Aliphatic organic chemical solvents containing hydroxyl- and/or ester- and/or ether groups such as, for example, glycol ethers, esters or similar are preferred for use.

Within the scope of the present invention, the known synthetic resin that is dilutable with water and/or soluble or dispersable or emulsifiable in the introduced organic chemical solvent, and/or binding drying oils, in particular binding media consisting of or containing an acrylic resin, a vinyl resin, for example, polyvinyl acetate, polyester resin, polycondensation- or polyaddition resin, polyurethane resin, alkyd resin or modified alkyd resin, phenol resin, hydrocarbon resin such as coumarone-indene resin, silicone resin, drying vegetable and/or drying oils and/or physically-drying binding agent on the basis of a natural- and/or synthetic resin, are used as organic chemical binding agents.

The synthetic resin used as a binding agent can be introduced in the form of an emulsion, dispersion or solution. Bitumen or bituminous substances can also be used as a binding agent up to 10% by weight. In addition, known dyestuffs, pigments, water-repelling agents, odour correctors and inhibitors or corrosion-prevention agents and the like can be used.

According to the invention, at least one alkyd resin or modified alkyd resin and/or a drying vegetable oil is preferred to be contained as an organic chemical binding agent in the medium or in the concentrate. According to the invention, alkyd resins with an oil content of more than 45% by weight, preferably 50 to 68% by weight are preferably used.

The mentioned binding agent can be replaced completely or partially by a fixing agent (mixture) or a plasticizer (mixture). The adjuncts should prevent volatilization of the active substances as well as crystallization or precipitation. Preferably, they replace 0.01 to 30% of the binding agent (in terms of 100% of the introduced binding agent).

The plasticiser originates from the chemical classes of the phthalic acid esters like dibutyl-, dioctyl- or benzyl butyl phthalate, phosphoric acid esters like tributyl phosphate, adipic acid esters like di(2-ethylhexyl)-adipate, stearates such as butyl stearate or amyl stearate, oleates such as butyl oleate, glycerine ether or high molecular glycol ether, glycerine esters such as p-toluol sulphonic acid ester.

Fixing agents are chemically based on polyvinyl alkyl ethers such as, for example, polyvinyl methyl ether or ketones like benzophenone, ethylene benzophenone.

Water is particularly qualified as a solvent or dilutant, if applicable, in mixture with one or more of the above-mentioned organic chemical solvents or dilutants, emulsifiers and dispersants.

A particularly effective protection of wood is achieved by means of industrial impregnation processes, for example, vacuum, double vacuum or pressure processes.

The agents that are ready for use can contain, if necessary, yet additional insecticides and, if necessary, still one or more fungicides.

The insecticides and fungicides mentioned in the WO 94/29 268 are especially qualified as additional mixture partners. The compounds mentioned in this document are an explicit component of the present application.

Especially preferred as mixture partners are insecticides such as chlorpyriphos, phoxim, silafluofen, alphamethrin, cyfluthrin, cypermethrin, deltamethrin, permethrin, imidacloprid, NI-25, flufenoxuron, hexaflumuron, transfluthrin, thiacloprid, methoxyfenozide, triflumuron, clothianidin, spinosad, tefluthrin,

as well as fungicides such as epoxiconazole, hexaconazole, azaconazole, propiconazole, tebuconazole, cyproconazole, metconazole, imazalil, dichlorfluanid, tolylfluanid, 3-iodide-2-propinyl butyl carbamate, n-octyl-isothiazolin-3-one and 4,5-dichloro-N-octylisothiazolin-3-one.

At the same time, the compounds according to the invention can be used to prevent the fouling of objects associated with sea or brackish water, in particular of ship bodies, sieves, nets, structures, wharf installations and signalling installations.

Fouling by sessile Oligochaetes such as tubificid worms as well as by mussels and species of the group Ledamorpha (barnacles), such as various Lepas- and Scalpellum species, or by species of the group Balanomorpha (barnacles), such as Balanus- or Pollicipes species, increases the friction resistance of ships and leads the way to increased energy consumption and, furthermore, to frequent stays in dry-dock for a conspicuous increase in operating costs.

Of particular importance alongside fouling by algaes, for example Ectocarpus sp. and Ceramium sp., belongs fouling by sessile Entomostraca groups, which are summarised under the title Cirripedia (tendril river crabs).

Surprisingly, it is now found that the compounds according to the invention—alone or in combination with other active substances—exhibit an excellent antifouling action.

By using the compounds according to the invention alone or in combination with other active substances, the use of heavy metals such as, for example, bis(trialkyltin)-sulphides, tri-n-butyltin laurate, tri-n-butyltin chloride, copper(I)-oxide, triethyl tin chloride, tri-n-butyl(2-phenyl-4-chlor-phenoxy)-tin, tributyl tin oxide, molybdenum disulphide, antimony oxide, polymeric butyl titanate, phenyl(bispyridine) bismuth chloride, tri-n-butyl tin fluoride, manganese ethylene bis thiocarbamate, zinc dimethyl dithiocarbamate, zinc ethylene bis thiocarbamate, zinc and copper salts of 2-pyridinthiol-1-oxide, bis dimethyl dithiocarbamoyl zinc ethylene bis thiocarbamate, zinc oxide, copper(I)-ethylene-bis dithiocarbamate, copper thiocyanate, copper naphthenate und tributyl tin halogenides can be foregone or the concentration of these compounds can be decisively reduced.

In any case, the antifouling paints that are ready for use can contain still other active substances, preferably algicides, fungicides, herbicides, molluscicides or other antifouling active substances.

Especially suitable as combination partners for the antifouling agent according to the invention are: Algicides such as 2-tert.-butylamino-4-cyclopropylamino-6-methylthio-1,3,5-triazine, dichlorophen, diuron, endothal, fentinacetate, isoproturon, methabenzthiazuron, oxyfluorfen, quinoclamine und terbutryn;

Fungicides such as benzo[b]thiophen carboxylic acid cyclohexylamine-S,S-dioxide, dichlofluanid, fluorfolpet, 3-iodine-2-propinyl-butyl carbamate, tolylfluanid und azoles such as azaconazole, cyproconazole, epoxyconazole, hexaconazole, metconazole, propiconazole und tebuconazole;

Molluscicides such as fentinacetate, metaldehyd, methiocarb, niclosamid, thiodicarb and trimethacarb, Fe-chelate,

or traditional antifouling active substances such as 4,5-dichlor-2-octyl-4-isothiazolin-3-one, diiod-methylparatrylsulphone, 2-(N,N-dimethylthiocarbamoylthio)-5-nitrothiazyl, potassium, copper, sodium and zinc salts from 2-pyridinthiol-1-oxide, pyridin-triphenylboran, tetrabutyldistannoxane, 2,3,5,6-tetrachlor-4-(methylsulphonyl)-pyridine, 2,4,5,6-tetrachloroisophthalonitrile, tetramethyl-thiuramdisulphide und 2,4,6-trichlorphenylmaleinimide.

The antifouling agents that are used contain the active substance according to the invention of the compounds according to the invention in a concentration of from 0.001 to 50% by weight, in particular from 0.01 to 20% by weight.

In addition, the antifouling agents according to the invention contain the traditional component parts such as described, for example, in Ungerer, Chem. Ind. 1985, 37, 730-732 and Williams, Antifouling Marine Coatings, Noyes, Park Ridge, 1973.

In addition to the algicides, fungicides, molluscicides and insecticidal active substances according to the invention, antifouling coating materials contain particular binding agents.

Examples of known binding agents are polyvinyl chloride in a solvent system, chlorinated rubber in a solvent system, acryl resin in a solvent system, particularly in an aqueous system, vinyl chloride/vinyl acetate copolymer systems in the form of aqueous dispersions or in the form of organic solvent systems, butadiene/styrol/acryl-nitrile rubber, drying oils such as flaxseed oil, resin ester or modified hard resins in combination with tar or bitumen, asphalt as well as epoxy compounds, limited amounts of chlororubber, chlorinated polypropylene and vinyl resins.

If applicable, coating materials also contain inorganic pigments, organic pigments or dyestuffs which are preferably insoluble in seawater. In addition, coating agents can contain materials like colophonium to make a controlled release of the active substances possible. The coatings can also be plasticisers that contain modification agents influenced by rheologic characteristics as well as other traditional component parts. In addition, the compounds according to the invention or the mixtures mentioned above can be included in self-polishing antifouling systems.

The active substance combinations are also suitable for combating animal pests, in particular insects, arachnids and mites, which appear in closed rooms such as, for example, habitations, factories, offices, vehicle cabins and others. They can be used alone or in combination with other active substances and excipients in household insecticide products for combating these pests. They are effective against sensitive and resistant species as well as against all development stages. To these pests belong:

From the order of the Scorpionida, for example, Buthus occitanus.

From the order of the Acarina, for example, Argas persicus, Argas reflexus, Bryobia spp., Dermanyssus gallinae, Glyciphagus domesticus, Ornithodorus moubat, Rhipicephalus sanguineus, Trombicula alfreddugesi, Neutrombicula autumnalis, Dermatophagoides pteronissimus, Dermatophagoides forinae.

From the order of the Araneae, for example, Aviculariidae, Araneidae.

From the order of the Opiliones, for example, Pseudoscorpiones chelifer, Pseudoscorpiones cheiridium, Opiliones phalangium.

From the order Isopoda, for example, Oniscus asellus, Porcellio scaber.

From the order Diplopoda, for example, Blaniulus guttulatus, Polydesmus spp.

From the order Chilopoda, for example, Geophilus spp.

From the order of the Zygentoma, for example, Ctenolepisma spp., Lepisma saccharina, Lepismodes inquilinus.

From the order of the Blattaria, for example, Blatta orientalies, Blattella germanica, Blattella asahinai, Leucophaea maderae, Panchlora spp., Parcoblatta spp., Periplaneta australasiae, Periplaneta americana, Periplaneta brunnea, Periplaneta fuliginosa, Supella longipalpa.

From the order of the Saltatoria, for example, Acheta domesticus.

From the order of the Dermaptera, for example, Forficula auricularia.

From the order of the Isoptera, for example, Kalotermes spp., Reticulitermes spp.

From the order of the Psocoptera, for example, Lepinatus spp., Liposcelis spp.

From the order of the Coleoptera, for example, Anthrenus spp., Attagenus spp., Dermestes spp., Latheticus oryzae, Necrobia spp., Ptinus spp., Rhizopertha dominica, Sitophilus granarius, Sitophilus oryzae, Sitophilus zeamais, Stegobium paniceum.

From the order of the Diptera, for example, Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga camaria, Simulium spp., Stomoxys calcitrans, Tipula paludosa.

From the order of the Lepidoptera, for example, Achroia grisella, Galleria mellonella, Plodia interpunctella, Tinea cloacella, Tinea pellionella, Tineola bisselliella.

From the order of the Siphonaptera, for example, Ctenocephalides canis, Ctenocephalides felis, Pulex irritans, Tunga penetrans, Xenopsylla cheopis.

From the order of the Hymenoptera, for example, Camponotus herculeanus, Lasius fuliginosus, Lasius niger, Lasius umbratus, Monomorium pharaonis, Paravespula spp., Tetramorium caespitum.

From the order of the Anoplura, for example, Pediculus humanus capitis, Pediculus humanus corporis, Phthirus pubis.

From the order of the Heteroptera, for example, Cimex hemipterus, Cimex lectularius, Rhodinus prolixus, Triatoma infestans.

The use in the area of household insecticides is made alone or in combination with other suitable active substances such as phosphoric acid esters, carbamates, pyrethroids, neonicotinoids, growth regulators or active substances from other known insecticide classes.

The use is made in aerosols, unpressurised sprays for example pump and atomiser sprays, nebulizing machines, foggers, foams, gels, vaporiser products with vaporizing dies made of cellulose or plastic, fluid vaporisers, gel and membrane vaporisers, propeller-driven vaporisers, weak or passive vaporizing systems, moth papers, moth sacks and moth gels, as granulates or dusts, in strewn baits or bait stations.

The effective action of the active substance combinations according to the invention results from the following examples. While the individual active substances exhibit weaknesses in effectiveness, the combinations exhibit an effectiveness that exceeds a simple summation of effectiveness.

A synergistic effect is present for insecticides and acaricides whenever the action of the active substance combinations is greater than the sum of the actions of the individually-applied active substances.

The action to be expected for a given combination of two active substance can be calculated as follows according to S. R. Colby, Weeds 15 (1967), 20-22:

If
X stands for the mortality rate expressed in % of the untreated control upon the use of active substance A at an application amount of m g/ha or in a concentration of m ppm,
Y stands for the mortality rate expressed in % of the untreated control upon the use of active substance B at an application amount of n g/ha or in a concentration of n ppm, and
E stands for the mortality rate expressed in % of the untreated control upon the use of active substances A and B at an application amount of m and n g/ha or in a concentration of m and n ppm,
then

$$E = X + Y - \frac{X \cdot Y}{100}$$

If the actual insecticidal mortality rate is greater than calculated, then the combination is exponential in its mortality; that is to say, a synergistic effect is present. In this case the mortality rate that is actually observed must be greater than the value for the expected mortality rate (E) calculated from the formula presented above.

### EXAMPLE A

### Aphis gossypii

### Test

Aphis gossypii
Test

| | |
|---|---|
| Solvent: | 7 Parts by weight dimethylformamide |
| Emulsifier: | 2 Parts by weight alkyl-aryl polyglycol ether |

To produce a suitable active substance preparation, one mixes 1 part by weight of active substance with the listed amount of solvent and emulsifier and dilutes the concentrate with water containing an emulsifier at the desired concentration.

Cotton leaves (Gossypium hirsutum), which are strongly affected by the cotton aphid (Aphis gossypii), are treated by immersion in the active substance preparation of the desired concentration.

After the desired time the desired time the mortality in % is determined. In the process, 100% means that all cotton aphids were killed; 0% means that no cotton aphids were killed. One calculates the determined mortality rate according to the Colby formula (see page 1).

With this test, for example, the following active substance combination according to the present application exhibits a synergistically-intensified effectiveness in comparison to the active substances used individually.

TABLE A
Insects that damage plants
Aphis gossypii - Test

| | Concentration | Mortality | |
|---|---|---|---|
| Active substance | in ppm | in % after 1^{d} | |
| Beta-cyfluthrin | 0.12 | 5 | |
| Thiacloprid | 0.6 | 35 | |
| | | enc.* | calc.** |
| Beta-cyfluthrin + Thiacloprid | 0.12 + 0.6 | 95 | 38.25 |
| (1:5) | | | |
| according to the invention | | | |

*enc. = encountered effect
**calc. = calculated effect according to the Colby formula

### EXAMPLE B

### Heliothis armigera

### Test

Heliothis armigera
Test

| | |
|---|---|
| Solvent: | 7 Parts by weight dimethylformamide |
| Emulsifier: | 2 Parts by weight alkyl-aryl polyglycol ether |

To produce a suitable active substance preparation, one mixes 1 part by weight of active substance with the listed amount of solvent and emulsifier and dilutes the concentrate with water containing an emulsifier at the desired concentration.

Cotton leaves (Gossypium hirsutum) are treated by immersion in the active substance preparation of the desired concentration and filled with cotton bollworm larvae (Heliothis armigera) for as long as the leaves are still damp.

After the desired time the desired time the mortality in % is determined. In the process, 100% means that all larvae were killed; 0% means that no larvae were killed. One determines the determined mortality rate according to the Colby formula (see page 1).

With this test the following active substance combination according to the present application exhibits a synergistically-intensified effectiveness in comparison to the active substances used individually.

TABLE B
Insects that damage plants
Heliothis armigera - Test

| | Concentration | Mortality | |
|---|---|---|---|
| Active substance | in ppm | in % after 6^{d} | |
| Beta-cyfluthrin | 0.12 | 0 | |
| Thiacloprid | 0.6 | 0 | |
| | | enc.* | calc.** |
| Beta-cyfluthrin + Thiacloprid (1:5) | 0.12 + 0.6 | 100 | 0 |
| according to the invention | | | |
| Lambda-cyhalothrin | 0.12 | 55 | |
| Thiacloprid | 0.12 | 0 | |
| | | enc.* | calc.** |
| Lambda-cyhalothrin + Thiacloprid | 0.12 + 0.12 | 100 | 55 |
| (1:1) | | | |
| according to the invention | | | |

*enc. = encountered effect
**calc. = calculated effect according to the Colby formula

### EXAMPLE C

### Myzus persicae

### Test

Myzus persicae
Test

| | |
|---|---|
| Solvent: | 7 Parts by weight dimethylformamide |
| Emulsifier: | 2 Parts by weight alkyl-aryl polyglycol ether |

To produce a suitable active substance preparation, one mixes 1 part by weight of active substance with the listed amount of solvent and emulsifier and dilutes the concentrate with water containing an emulsifier at the desired concentration.

Cabbage leaves (Brassica oleracea) that are severely afflicted by the green peach aphid (Myzus persicae) are treated by immersion in the active substance preparation of the desired concentration.

After the desired time the desired time the mortality in % is determined. In the process, 100% means that all green peach aphids were killed; 0% means that no green peach aphids were killed. One calculates the determined mortality rate according to the Colby formula (see page 1).

With this test, for example, the following active substance combination according to the present application exhibits a synergistically-intensified effectiveness in comparison to the active substances used individually.

TABLE C
Insects that damage plants
Myzus persicae
Test

| | Concentration | Mortaility | |
|---|---|---|---|
| Active substance | inppm | in % after 6^{d} | |
| Beta-cyfluthrin | 0.12 | 0 | |
| Thiacloprid | 0.6 | 35 | |
| | | enc.* | calc.** |
| Beta-cyfluthrin + Thiacloprid (1:5) | 0.12 + 0.6 | 95 35 | |
| according to the invention | | | |
| Bifenthrin | 0.16 | 0 | |
| Thiacloprid | 0.8 | 0 | |
| | | enc.* | calc.** |
| Bifenthrin + Thiacloprid (1:5) | 0.16 + 0.8 | 40 | +111 0 |
| according to the invention | | | |
| Gamma-cyhalothrin | 0.032 | 0 | |
| Thiacloprid | 0.8 | 10 | |
| | | enc.* | calc.** |
| Gamma-cyhalothrin + Thiacloprid | 0.032 + 0.8 | 35 | 10 |
| (1:25) according to the invention | | | |

*enc. = encountered effect
**calc. = calculated effect according to the Colby formula

### EXAMPLE D

Phaedon cochleariae-Larvae
Tes

| | |
|---|---|
| Solvent: | 7 Parts by weight dimethylformamide |
| Emulsifier: | 2 Parts by weight alkyl-aryl polyglycol ether |

To produce a suitable active substance preparation, one mixes 1 part by weight of active substance with the listed amount of solvent and emulsifier and dilutes the concentrate with water containing an emulsifier at the desired concentration.

Cabbage leaves (Brassica oleracea) are treated by immersion in the active substance preparation of the desired concentration and filled with mustard beetle larvae (Phaedon cochleariae) for as long as the leaves are still damp.

After the desired time the desired time the mortality in % is determined. In the process, 100% means that all beetle larvae were killed; 0% means that no beetle larvae were killed. One determines the determined mortality rate according to the Colby formula (see page 1).

With this test the following active substance combination according to the present application exhibits a synergistically-intensified effectiveness in comparison to the active substances used individually.

TABLE D
Insects that damage plants
Phaedon cochleariae larvae
Test

| | Concentration | Mortality | |
|---|---|---|---|
| Active substance | in ppm | in % after 6^{d} | |
| Beta-cyfluthrin | 0.12 | 15 | |
| Thiaccloprid | 3 | 15 | |
| | | enc.* | calc.** |
| Beta-cyfluthrin + Thiacloprid (1:25) | 0.12 + 3 | 100 | 27.75 |
| according to the invention | | | |
| Alpha-cypermethrin | 0.16 | 5 | |
| Thiacloprid | 4 | 5 | |
| | | end.* | calc.** |
| Alpha-cypermethrin + Thiacloprid | 0.16 + 4 | 55 | 9.75 |
| (1:25) according to the invention | | | |
| Bifenthrin | 0.8 | 35 | |
| Thiacloprid | 4 | 30 | |
| | | enc.* | calc.** |
| Bifenthrin + Thiacloprid (1:5) | 0.8 + 4 | 100 | 54.5 |
| according to the invention | | | |
| Deltamethrin | 0.16 | 30 | |
| Thiacloprid | 20 | 40 | |
| | | enc.* | calc.** |
| Deltamethrin + Thiacloprid (1:25) | 0.16 + 20 | 90 | 58 |
| according to the invention | | | |

*enc. = encountered effect
*calc. = calculated effect according to the Colby formula

### EXAMPLE E

Plutella xylostella
Test (sensitive strain)

| | |
|---|---|
| Solvent: | 7 Parts by weight dimethylformamide |
| Emulsifier: | 2 Parts by weight alkyl-aryl polyglycol ether |

To produce a suitable active substance preparation, one mixes 1 part by weight of active substance with the listed amount of solvent and emulsifier and dilutes the concentrate with water containing an emulsifier at the desired concentration.

Cabbage leaves (Brassica oleracea) are treated by immersion in the active substance preparation of the desired concentration and filled with cabbage moth larvae (Plutella xylostella) for as long as the leaves are still damp.

After the desired time the desired time the mortality in % is determined. In the process, 100% means that all larvae were killed; 0% means that no larvae were killed. One determines the determined mortality rate according to the Colby formula (see page 1).

With this test the following active substance combination according to the present application exhibits a synergistically-intensified effectiveness in comparison to the active substances used individually.

TABLE E
Insects that damage plants
Plutella xylostella - Test (normal sensitivity)

| | Concentration | | |
|---|---|---|---|
| Active substance | in ppm | Mortality in % after 6^{d} | |
| Beta-cyfluthrin | 0.024 | 10 | |
| Thiacloprid | 0.6 | 0 | |
| | | enc.* | calc.** |
| Beta-cyfluthrin + | 0.024 + 0.6 | 40 | 10 |
| Thiacloprid (1:25) | | | |
| according to the invention | | | |
| Lambda-cyhalothrin | 0.024 | 40 | |
| Thiacloprid | 0.6 | 0 | |
| | | enc.* | calc.** |
| Lambda-cyhalothrin + | 0.024 + 6 | 80 | 40 |
| Thiacloprid (1:25) | | | |
| according to the invention | | | |

*enc. = encountered effect
**calc. = calculated effect according to the Colby formula

### EXAMPLE F

Plutella xylostella
Test (resistant strain)

| | |
|---|---|
| Solvent: | 7 Parts by weight dimethylformamide |
| Emulsifier: | 2 Parts by weight alkyl-aryl polyglycol ether |

To produce a suitable active substance preparation, one mixes 1 part by weight of active substance with the listed amount of solvent and emulsifier and dilutes the concentrate with water containing an emulsifier at the desired concentration.

Cabbage leaves (Brassica oleracea) are treated by immersion in the active substance preparation of the desired concentration and filled with cabbage moth larvae (Plutella xylostella) for as long as the leaves are still damp.

After the desired time the desired time the mortality in % is determined. In the process, 100% means that all larvae were killed; 0% means that no larvae were killed. One determines the determined mortality rate according to the Colby formula (see page 1).

With this test the following active substance combination according to the present application exhibits a synergistically-intensified effectiveness in comparison to the active substances used individually.

TABLE F
Insects that damage plants
Plutella xylostella - Test (resistant)

| | Concentration | | |
|---|---|---|---|
| Active substance | in ppm | Mortality in % after 6^{d} | |
| Beta-cyfluthrin | 0.6 | 35 | |
| Thiacloprid | 3 | 0 | |
| | | enc.* | calc.** |
| Beta-cyfluthrin + | 0.6 + 3 | 85 | 35 |
| Thiacloprid (1:5) | | | |
| according to the invention | | | |
| Lambda-cyhalothrin | 0.6 | 40 | |
| Thiacloprid | 15 | 10 | |
| | | enc.* | calc.** |
| Lambda-cyhalothrin + | 0.6 + 15 | 85 | 46 |
| Thiacloprid (1:25) | | | |
| according to the invention | | | |

*enc. = encountered effect
**calc. = calculated effect according to the Colby formula

### EXAMPLE G

Spodoptera exigua
Test

| | |
|---|---|
| Solvent: | 7 Parts by weight dimethylformamide |
| Emulsifier: | 2 Parts by weight alkyl-aryl polyglycol ether |

To produce a suitable active substance preparation, one mixes 1 part by weight of active substance with the listed amount of solvent and emulsifier and dilutes the concentrate with water containing an emulsifier at the desired concentration.

Cabbage leaves (Brassica oleracea) are treated by immersion in the active substance preparation of the desired concentration and filled with beet armyworm larvae (Spodoptera exigua) for as long as the leaves are still damp.

After the desired time the desired time the mortality in % is determined. In the process, 100% means that all larvae were killed; 0% means that no larvae were killed. One determines the determined mortality rate according to the Colby formula (see page 1).

With this test the following active substance combination according to the present application exhibits a synergistically-intensified effectiveness in comparison to the active substances used individually.

TABLE G
Insects that damage plants
Spodoptera exigua - Test

| | Concentration | | |
|---|---|---|---|
| Active substance | in ppm | Mortality in % after 6^{d} | |
| Beta-cyfluthrin | 0.6 | 25 | |
| Thiacloprid | 15 | 0 | |
| | | enc.* | calc.** |
| Beta-cyfluthrin + | 0.6 + 15 | 100 | 25 |
| Thiacloprid (1:25) | | | |
| according to the invention | | | |

*enc. = encountered effect
**calc. = calculated effect according to the Colby formula

### EXAMPLE H

Spodoptera frugiperda
Test

| | |
|---|---|
| Solvent: | 7 Parts by weight dimethylformamide |
| Emulsifier: | 2 Parts by weight alkyl-aryl polyglycol ether |

To produce a suitable active substance preparation, one mixes 1 part by weight of active substance with the listed amount of solvent and emulsifier and dilutes the concentrate with water containing an emulsifier at the desired concentration.

Cabbage leaves (Brassica oleracea) are treated by immersion in the active substance preparation of the desired concentration and filled with fall armyworm larvae (Spodoptera frugiperda) for as long as the leaves are still damp.

After the desired time the desired time the mortality in % is determined. In the process, 100% means that all larvae were killed; 0% means that no larvae were killed. One determines the determined mortality rate according to the Colby formula (see page 1).

With this test the following active substance combination according to the present application exhibits a synergistically-intensified effectiveness in comparison to the active substances used individually.

TABLE H
Insects that damage plants
Spodoptera frugiperda - Test

| | Concentration | | |
|---|---|---|---|
| Active substance | in ppm | Mortality in % after 3^{d} | |
| Beta-cyfluthrin | 0.12 | 5 | |
| Thiacloprid | 0.6 | 0 | |
| | | enc.* | calc.** |
| Beta-cyfluthrin + | 0.12 + 0.6 | 100 | 5 |
| Thiacloprid (1:5) | | | |
| according to the invention | | | |

*enc. = encountered effect
**calc. = calculated effect according to the Colby formula

What is claimed is:

1-5. (canceled)

6: A mixture comprising thiacloprid and one or more compounds selected from the group consisting of acrinathrin, alpha-cypermethrin, betacyfluthrin, cyhalothrin, cypermethrin, deltamethrin, esfenvalerate, etofenprox, fenpropathrin, fenvalerate, flucythrinate, lambda-cyhalothrin, permethrin, tau-fluvalinate, tralomethrin, zeta-cypermethrin, cyfluthrin, bifenthrin, cycloprothrin, eflusilanate, fubfenprox, pyrethrin, resmethrin, and gamma-cyhalothrin.

7: A method of combating animal pests comprising applying an effective amount of a mixture according to claim 6 to the animal pests and/or their habitat.

8: A composition comprising a mixture according to claim 6 and one or more extenders and/or surface-active substances.

9: A method for the production of insecticidal agents comprising mixing a mixture according to claim 6 with one or more extenders and/or surface-active substances.
